(19) United States
(12) Patent Application Publication
(10) Pub. No.: US 2011/0290198 A1
(43) Pub. Date: Dec. 1, 2011

(54) Method and device for preventing pets from clawing home furnishings

(76) Inventor: Bonnie Pemberton, Coppell, TX (US)

(21) Appl. No.: 13/136,545

(22) Filed: Aug. 4, 2011

Related U.S. Application Data
(63) Continuation-in-part of application No. 11/084,540, filed on Mar. 18, 2005.
Application No. 11/084,540 is a continuation of application No. 08/810,049, filed on Mar. 4, 1997, now Pat. No. 6,692,594.
(60) Provisional application No. 60/012,825, filed on Mar. 5, 1996.

(51) Int. Cl. A01K 29/00

(52) U.S. Cl. 119/712

(57) ABSTRACT

An apparatus and method is provided for controlling animal activity with an adhesive sheet. In one embodiment, the sheet includes strips uniformly spaced apart on a transfer layer including a bisected protection layer. In another embodiment, the sheet is flat and generally rectangular. In another embodiment, the sheet is rolled. In yet another embodiment, the sheet is deployed from a dispenser. In one embodiment of the method, the sheet is deployed by locating an area of activity to be controlled, removing the control sheet from the transfer sheet, placing the control sheet on an the area of activity to be controlled and then systematically and sequentially removing the first protection sheet and the second protection sheet. In another embodiment, the area to be controlled includes a surface discontinuity requiring placement of the control sheet along the discontinuity.

### CROSS-REFERENCES TO RELATED APPLICATIONS

This application is a continuation-in-part of U.S. application Ser. No. 11/084,540 entitled “Method and Device for Preventing Pets from Clawing Home Furnishings” filed Mar. 18, 2005 which is a continuation of U.S. application Ser. No. 08/810,049, filed Mar. 4, 1997, which claims the benefit of U.S. Provisional Application No. 60/012,825, filed Mar. 5, 1996.

### FIELD OF INVENTION

This invention relates in general to animal control methods, and in particular to a method and device for preventing pets from clawing furniture or digging in potted plants.

### BACKGROUND OF INVENTION

Some animals such as cats tend to naturally claw at or scratch home furnishings. If allowed to continue, such activity can significantly deface and even damage the furniture. Animals also defecate and meander in unwanted places. There are a number of methods for deterring many types of animals from causing and engaging in unwanted activity.

Prior art devices include those shown in Italy Patent No. 590,156, U.S. Pat. No. 4,587,146 to Anhäuser, et al.; Claws and All: Living With Your Cat, Your Furniture, and Your Peace of Mind, Rachel Lamb from the Spring 1996 HSUS News,© 1996 the HSUS; and Basic Training for Your Cat,© 1995 Bohnenkamp, Perfect Paws, Inc.

### BRIEF DESCRIPTION OF THE DRAWINGS

FIG. 1 is a plan view of a preferred embodiment an array of strips.

FIG. 2 is an enlarged, partial sectional view of a preferred embodiment of the strips of FIG. 1 taken along line 2-2.

FIG. 3 is a schematic drawing of the strips of FIG. 1 affixed to furniture.

FIG. 4 is a sectional view of an alternate preferred embodiment.

FIG. 5 is a schematic drawing of the embodiment of FIG. 4 in use.

FIG. 6 is an isometric view of the strip of an alternate preferred embodiment.

FIG. 7 is an enlarged, partial sectional view of the strip of FIG. 6 taken along line 7-7.

FIG. 8 is an isometric view of an alternate preferred embodiment.

FIG. 9 is a stretched alternate preferred embodiment of the strip of FIG. 8.

FIG. 10 is a schematic drawing of the strip of FIG. 8 in use.

FIG. 11 is a schematic drawing of various applications of a preferred embodiment.

FIG. 12 is a schematic drawing of a preferred embodiment affixed to corners of a piece of furniture.

FIG. 13 is an isometric view of an alternate preferred embodiment.

FIG. 14 is an enlarged, partial sectional view of the strip of FIG. 13 taken along the line 14-14.

FIG. 15 is an isometric view of a preferred embodiment of a dispensing housing.

FIG. 16 is an isometric view of an alternate preferred embodiment.

FIG. 17 is an enlarged, partial sectional view of the strip of FIG. 16 taken along the line 17-17.

### DETAILED DESCRIPTION OF THE PREFERRED EMBODIMENT

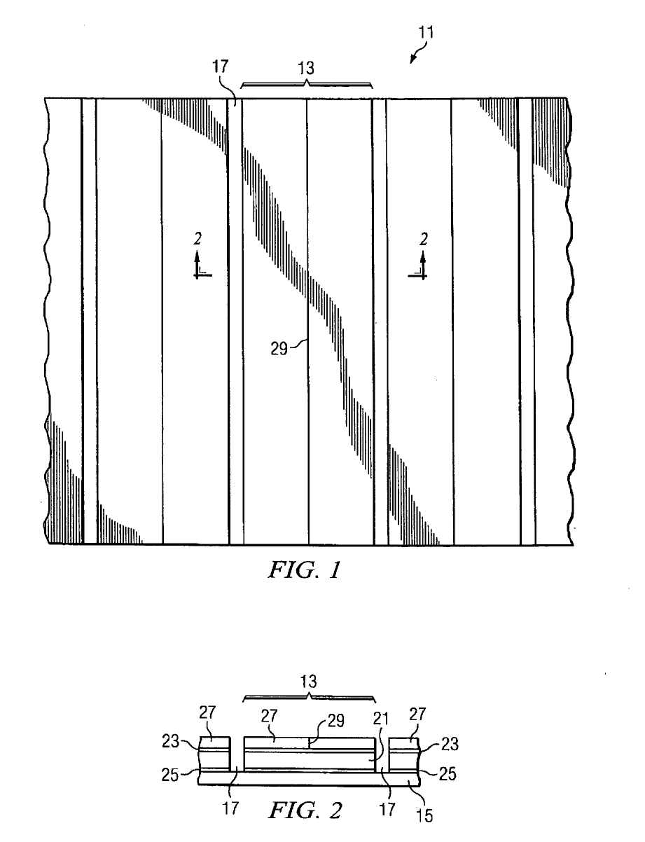

Referring to FIGS. 1 and 2, an array 11 of multilaminate, rectangular strips 13 is shown. Each strip 13 is approximately twelve inches long and two inches wide. Strips 13 are affixed to a paper transfer sheet 15 and are uniformly spaced apart from one another by gaps 17. Each strip 13 has a plastic substrate or film 21 which provides the backing for two adhesive coating 23, 25 located on both sides of strip 13. Strips 13 and coatings 23, 25 are preferably transparent so as to appear substantially invisible when affixed to furniture. Coatings 23, 25 are preferably acrylic or a similar water based adhesive and can easily be removed from home furnishing fabrics. Coating 25 creates a releasable bond between film 21 and transfer sheet 15. The upper surface of transfer sheet 15 is treated with paraffin to facilitate easy removal of strips 13 from transfer sheet 15. A paper protective or release layer 27 is affixed to film 21 above coating 23. The lower surface of release layer 27 is treated with paraffin to facilitate easy removal of release layer 27 from film 21. In the embodiment shown, release layer 27 is longitudinally bisected into two separate portions as shown by cut 29.

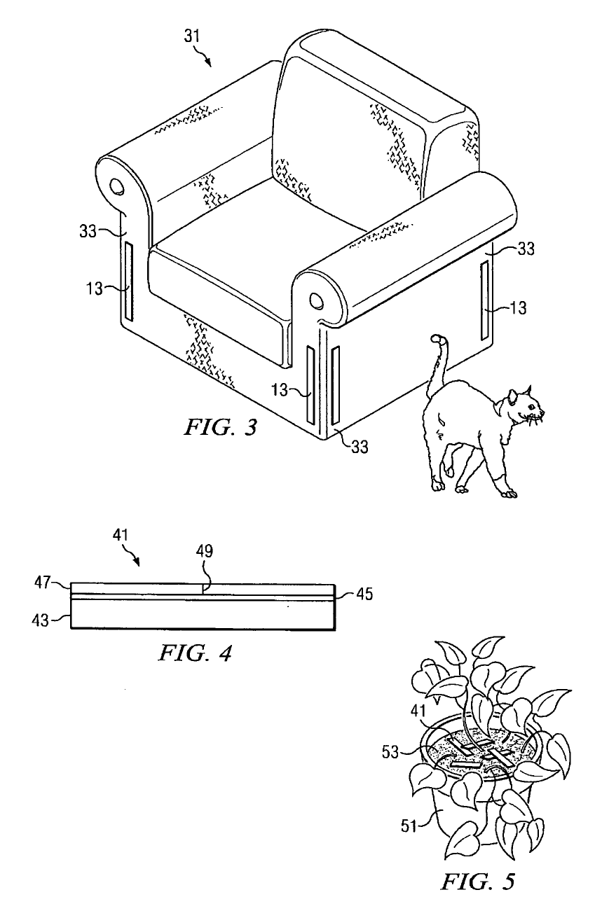

In operation, strip 13 is peeled from transfer sheet 15 so that adhesive coating 25 is exposed. Gaps 17 between strips 13 provide an indication of the side margins of each strip 13 so as to not confuse cut 29 with the side margins. Referring to FIG. 3, the user then presses strip 13 against an item of furniture 31, a countertop, or other object where a cat may tread or tend to “sharpen” its claws. Coating 25 removably affixes strip 13 to fabric home furnishings such as drapery or an item of furniture 31 along an outer surface 33. If necessary, strip 13 may be repositioned after it is affixed to furniture 31. Finally, release layer 27 is easily removed from strip 13 by peeling the two portions of release layer 27 along cut 29, thereby exposing coating 23. These steps are then repeated for each surface 33 that is susceptible to be scratched. Since it is transparent, strip 13 is not readily visible after release layer 27 is removed. When a cat attempts to scratch furniture 31, its paw contacts and receives an unpleasant sticking sensation from exposed adhesive coating 23, deterring the cat from future contact with that item of furniture 31. Coating 25 is of sufficient strength so as to remain affixed to furniture 31 when cats or other pets attempt to scratch furniture 31.

An alternate embodiment of the invention is shown in FIG. 4. Strip 41 has a rectangular corrugated plastic substrate 43 topped by adhesive coating 45. There is no coating of adhesive on the lower side of strip 41. Substrate 43 and coating 45 are impervious to water. Substrate 43 is fairly rigid and is preferably colored to blend in with soil. Coating 45 creates a bond between substrate 43 and paper release layer 47. The lower surface of release layer 47 is treated with paraffin to facilitate easy removal of release layer 47 from substrate 43. Release layer 47 is longitudinally bisected into two portions by cut 49. The size of each strip 41 may vary, but is typically about the same size as strip 13 of the first embodiment. If necessary, strip 41 may be cut or trimmed to meet a particular application.

In operation, release layer 47 is easily removed from strip 41 by peeling release layer 47 along cut 49, thereby exposing coating 45. Referring to FIG. 5, strip 41 is placed in a potted houseplant 51 so that the lower, nonadhesive side of substrate 43 lies in contact with soil 53. Preferably, a plurality of strips 41 are placed on soil 53 and overlapped transverse to one another. When strips 41 are overlapped, the coating 45 on one strip 41 sticks to the non-coated side of another strip 41. This alignment creates an array of strips that is not easily lifted by a pet. When a cat attempts to dig in soil 53, it contacts and receives an unpleasant sticking sensation from exposed adhesive coating 45 and is deterred from future contact with soil 53 of houseplant 51.

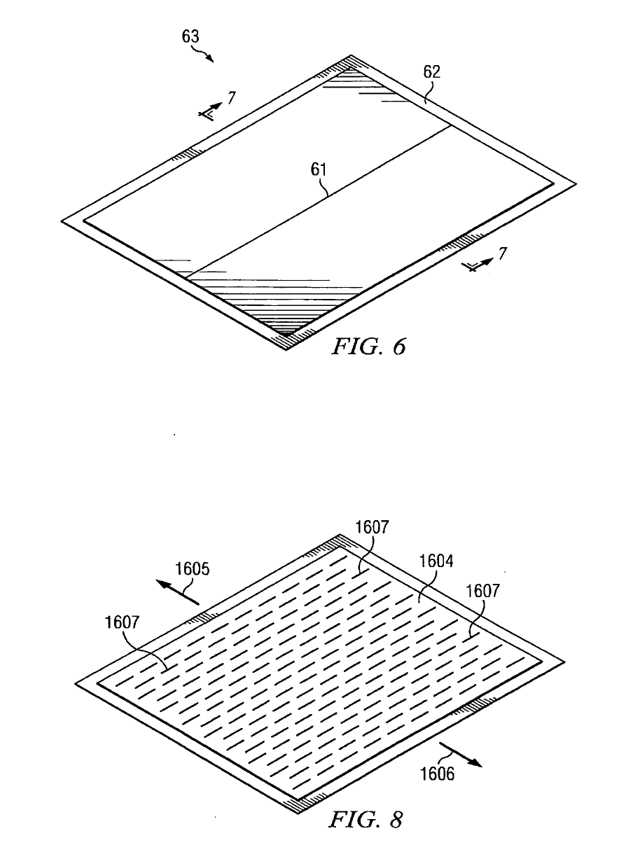

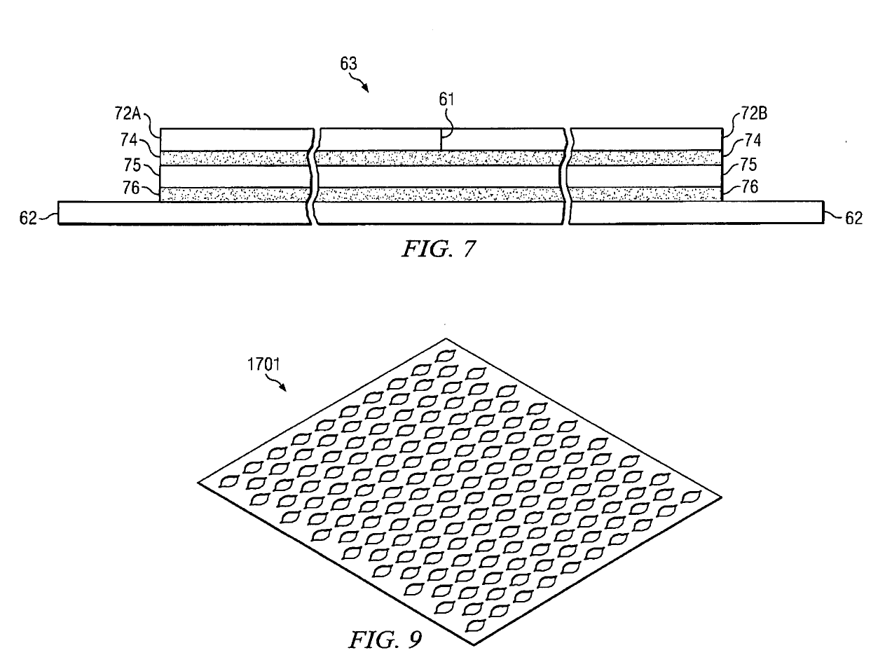

Referring to FIGS. 6 and 7, an alternate embodiment is shown as strip 63. In the alternate embodiment, strip 63 is approximately 11 inches long and 8 inches wide. In the preferred embodiment, the surface area is rectangular tape about 16 square inches. Strip 63 is affixed to paper transfer layer 62. In the preferred embodiment, transfer layer 62 is approximately 12 inches long and 9 inches wide. Of course other dimensions of the strip and transfer sheet can be used with equal success. Other shapes besides rectangular could be provided in alternative embodiments, as well, such as polygons or ellipses.

Referring to FIG. 7, a side view of strip 63 is shown. It is comprised of five layers. The first layer, transfer layer 62, is a wax coated paper. In other embodiments, transfer layer 62 can be a thin polypropylene sheet or other sheet materials having at least one slick surface. The second layer is first adhesive coating 76. First adhesive coating 76 in the preferred embodiment is a water based adhesive which can easily be removed and reattached from objects such as home furnishings or carpets. In the preferred embodiment, first adhesive coating 76 is a polyacrylate adhesive which is transparent, odorless and tasteless. In other embodiments first adhesive coating 76 can be styrene-isoprene-styrene, styrene-butadiene-styrene, poly(butyl acrylate), poly(2-octyl acrylate), styrene-isoprene-styrene or poly(ethylhexyl acrylate). In any of the embodiments described herein, a scented adhesive, such as a citrus scent, can be employed. All embodiments could also be coated with agents with a disagreeable taste, such as a citrus flavor. Also any of the embodiments can have color or designs can be added to the adhesive. The thickness of first adhesive coating 76 is approximately one to two mils thick. Other thickness of adhesive can be used. The greater the thickness of first adhesive coating 76, the easier it will be to remove strip 63 when it has been affixed to a surface.

The third layer is transparent layer 75. First adhesive coating 76 adheres to one side of transparent layer 75, forming a bond not easily removed. In the preferred embodiment, transparent layer 75 is a transparent polypropylene sheeting approximately one to two mils thick. In an alternate embodiment, colors and designs can be added to transparent layer 75. Thicknesses of up to five mils can be used depending on the desired application of the embodiment. The durability and rigidity of the sheet increases as the thickness increases. As will be obvious to those skilled in the art, the economy of the transparent layer increases as the thickness decreases.

In an alternate embodiment first adhesive coating 76 is intermittently applied to the strip. The placement of first adhesive coating 76 can be applied to less than the full surface area of layer 75. For instance, the adhesive coating may be applied in a pattern or shape. First adhesive coating 76 can also be arranged in parallel lines, non-parallel serpentine patterns or in other patterns. If colored, the adhesive can take on decorative patterns such as floral patterns. In one preferred embodiment, the adhesive is arranged in a series of parallel lines lengthwise on layer 75. In this embodiment, the width of each parallel line is about 2 millimeters. The space between the lines is about one centimeter. The resulting adhesive coverage is about 20% of the surface of layer 75. Smaller layer percentages of coverage can be employed in different embodiments to adjust adhesive coverage to delicate or robust surfaces.

The fourth layer comprises second adhesive coating 74. Second adhesive coating 74 is preferably a polyacrylate adhesive or other similar water based adhesive which is transparent, non-toxic, odorless and tasteless. In other embodiments second adhesive coating 74 can be styrene-isoprene-styrene, styrene-butadiene-styrene, poly(butyl acrylate), poly(2-octyl acrylate), styrene-isoprene-styrene or poly(ethylhexyl acrylate). Second adhesive coating 74 adheres to a surface of transparent layer 75 with a bond not easily removed. In the preferred embodiment, first adhesive coating 76 and second adhesive coating 74 are both water based adhesives. In any of the embodiments described herein, at least first adhesive coating 74 or second adhesive coating 76 can be formed of a water insoluable adhesive.

The fifth layer of strip 63 is a release layer separated into two pieces 72a and 72b. In the preferred embodiment, the pieces are wax coated paper. However, in other embodiments, a thin polypropylene plastic or other flexible sheet can be used. As can be seen from FIG. 6, pieces 72a and 72b are separated by a dividing line 61 along the long axis of transfer layer 62. In any of the embodiments described herein, release layer 72a and 72b can be separated along an axis or diagonally, depending on the application desired. In an alternative embodiment, words, designs or colors may be added to the exposed surface of pieces 72a and 72b.

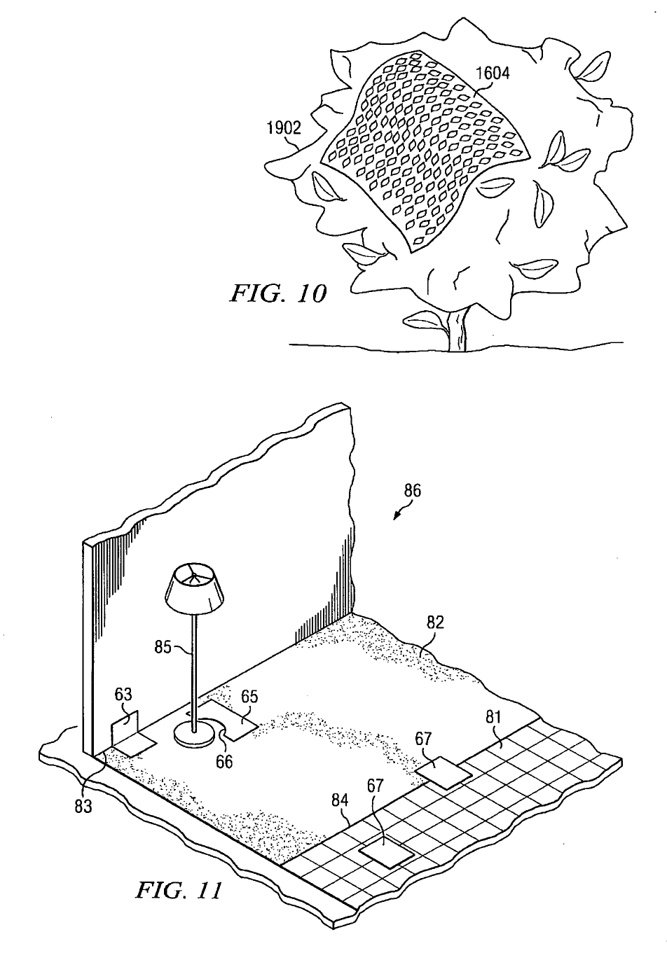

FIG. 8 shows an alternate embodiment which includes diagonally staggered perforations 1607. Perforations 1607 are cut into the strip by a roller or other available means known in the art. In the preferred embodiment, each linear perforation 1607 is approximately one inch long and occurs at a frequency of three perforations per square inch. Of course other dimensions and frequencies of perforations can be used with equal success. The greater the number of perforations, the more the strip can be expanded. In use, after transparent layer 75 is peeled from transfer layer 62, transparent layer 75 is expanded by stretching the strip outward, as shown by arrows 1605 and 1606, in a direction perpendicular to the linear length of the perforations. FIG. 9 shows expanded perforated strip 1701. All five layers of the strip can be perforated or only the transparent layer can be perforated. FIG. 10 shows use of this embodiment on an irregular surface 1902.

For any of the embodiments disclosed herein, the desired locations can be carpets, floors, dirt, patios or other generally horizontal surfaces to prevent unwanted defecation or meandering or walls, drapes, furniture, plant stems, trees, wires, lamp posts, trashcans, BBQ grills or other generally vertical surfaces to prevent scratching or clawing of animals. The embodiments with incidental placement of adhesive are suited to be used on delicate areas such as vehicles, vehicle covers and fine fabrics. Perforated embodiments are well suited for irregular shaped objects such as bushes and fences, but can also be used with equal success on other horizontal or vertical surfaces. Any of the embodiments disclosed herein can also be used with equal success to deter the behavior of birds, rodents, or other animals.

In use, transparent layer 75 is peeled from transfer layer 62, leaving adhesive coating 76 on transparent layer 75 exposed. Two piece release layer 72a and 72b remains affixed to transparent layer 75 to give rigidity to transparent layer 75 and to aid in positioning the strip.

First adhesive coating 76 is pressed onto the desired surface by an application of pressure to the exposed surface of release layer 72a and 72b. If necessary, strip 63 may be reposition after it is affixed. Two piece release layer 72a and 72b remains affixed to strip 63 to aid in repositioning. Release layer 72a and 72b is removed from strip 63 by peeling the two separate portions of the release layer along division 61, one at a time, thereby exposing second adhesive coating 74.

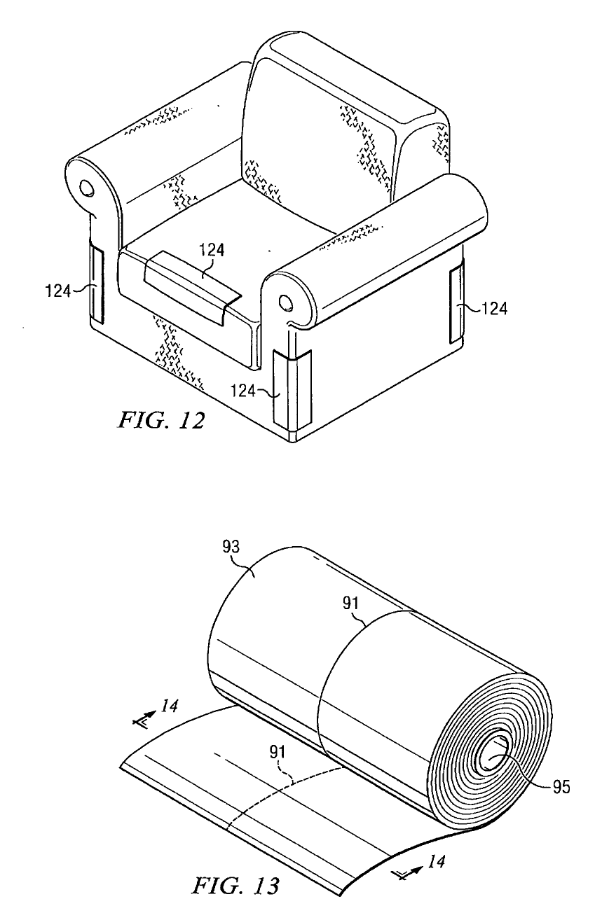

FIG. 11 shows use of the invention in environment 86. Environment 86 includes corner 83, furniture 85, horizontal carpet surface 82 and horizontal slick surface 81. Strip 63 is shown in position along corner 83. In this location, first adhesive coating 76 is pressed against corner 83 along division 61 between two-piece release layer 72a and 72b. Release layers 72a and 72b are removed from strip 63 by peeling each piece one at a time. It will be appreciated by those in the art that it would be difficult or impossible to remove release layers 72a and 72b if they were in fact one piece. Wrinkling, tearing and damage to transparent layer 75 would occur in this instance.

Still referring to FIG. 11, an item of furniture 85 is shown. In this usage, the strip is cut along shape 66 to match or avoid item of furniture 85. After modifying strip 65 by cutting, the transparent layer is removed from the transfer layer and positioned as desired. Then, the release layer is removed a strip at a time and positioned on carpet surface 82.

In another application, strip 67 is placed on flat surface 81 in the area where the presence of the pet is to be deterred.

In another application, strip 67 is placed along interface 84 between carpet surface 82 and flat surface 81. In this application, transparent layer 75 at strip 67 is placed along interface 84 generally aligning division 61 with the interface. Two-piece release 72a and 72b is then removed one strip at a time to prevent damage to transparent layer 75.

In an alternate embodiment, the transfer layer and release layer can be placed on the corner of an object. For example, referring to FIG. 12, an alternate embodiment of the preferred invention is shown deploying the release layer and transparent layer on a corner of the surface. The steps of this alternate embodiment include removing the transparent layer from the transfer layer, placing the first adhesive layer along one side of the corner, centering the corner along the axis of the cut, bending the transparent layer along the axis of the cut, pressing the second side of the transparent layer 124 against the article and removing release layer 72a and finally removing release layer 72b. In this alternate embodiment, division 61 allows release layers 72a and 72b to be removed without being torn. Of course, this method can be applied to corners of any orientation such as a horizontal corner. Deploying the invention along a corner as described is very difficult with a single release layer as in the prior art.

If transparent, first adhesive coating 76, second adhesive coating 74, and transparent layer 75 are not readily visible after release layer 72a and 72b are removed. Coating 76 is of sufficient thickness and strength to remain affixed to the surfaces to which they are affixed when repeatedly contacted.

Referring to FIG. 10, use of an alternative embodiment is pictured. In this embodiment, the release layer is removed from a transparent layer. The perforated transparent layer, still attached to the perforated release layer, is then stretched perpendicularly to the axis of the perforations expanding the coverage area of the device. The transparent layer is then placed on the irregular object and the release layer is removed.

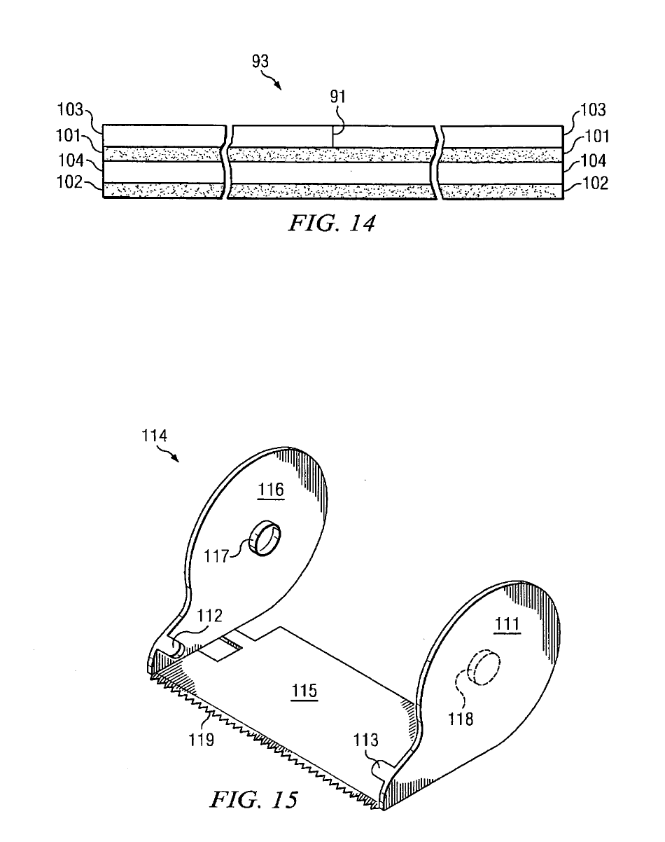

Referring to FIGS. 13 and 14, an alternate embodiment is shown as a cylinder of multilayer laminate 93. In this preferred embodiment, multilayer laminate 93 is approximately 96 inches long and two inches wide. In the preferred embodiment, the length of the multilayer laminate is much longer than its width, but of course other the dimensions can be used with equal success.

Referring to FIG. 14, multilayer laminate 93 has four layers. The first layer, film 104, provides backing for the second and third layers or first adhesive coating 101 and second adhesive coating 102. The fourth layer, two piece release layer 103, is releasably adhered to film 104 by coating 101. Coatings 101 and 102 are preferably polyacrylate or a similar water based adhesive. In an alternate embodiment, coating 102 is ¼ square inch wide located perpendicular to the axis of film 104. Of course other widths or other arrangements of intermit adhesive coatings can be used with equal success. This embodiment allows film 104 to be removably adhered to a surface without requiring the adhesive coating to cover the entire surface covered by film 104. The upper and lower surfaces of two piece release layer 103 are treated with paraffin to facilitate easy removal of film 104. Multilayer laminate 93 is generally stored in and deployed from a rolled position, therefore both sides of release layer 103 are required to be easily separated from coatings 101 and 102. In the embodiment shown, two piece release layer 103 is longitudinally bisected into two separate portions along division 91.

As shown in FIG. 13, the multilayer laminate is comprised of a spooled strip in which coating 102 is in contact with the top surface of release layer 103 in successive layers. Multilayer laminate 93 is spooled on a rigid cylinder 95. In the preferred embodiment, the cylinder is made of cardboard but could also be made of a rigid plastic or a light metal. In operation, multilayer laminate 93 is unwound from cylinder 95 to a desired length, exposing coating 102. The desired length of multilayer laminate 93 is separated from the cylinder by using a cutting utensil such as scissors or a razor blade.

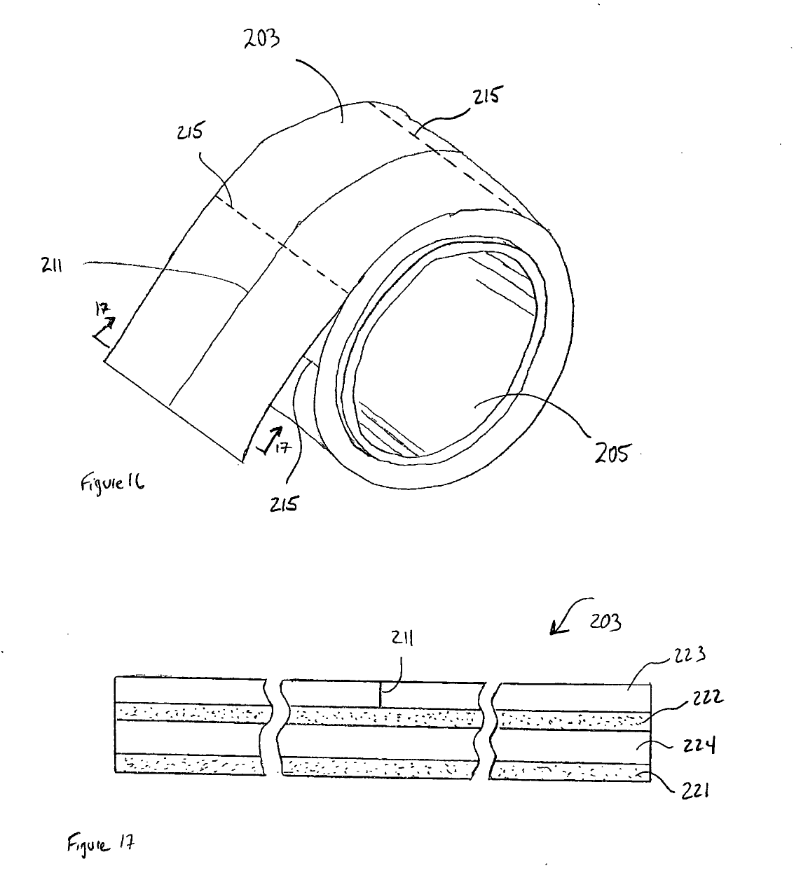

Referring to FIG. 15, housing 114 can be used to facilitate the detachment of multilayer laminate 93 from cylinder 95. Housing 114 is comprised of two generally parallel support arms 116 and 111. Support arms 116 and 111 are connected by support bar 115 having serrated edge 119. Support arm 116 includes inward facing cylinder support 117 while support arm 111 includes a diametrically opposed inward facing cylinder support 118. Support cylinder 116 includes tab 112 and support cylinder 111 includes tab 113. Housing 114 in the preferred embodiment is made of a polypropylene plastic which is colored as desired. Of course, other plastics and flexible metals can be used as well. In the preferred embodiment, serrated edge 119 is made of a light metal, but can also be formed from the same material as housing 114.

In use, cylinder 95 with rolled up multilayer laminate 93 thereon is positioned between support arm 116 and support arm 111 and held in place by cylinder support 117 and cylinder support 118. The diameters of cylinder support 117 and cylinder support 118 are sized so as to be slightly less than the diameter of cylinder support 95 and thus provide a snug but easily rotatable fit. The result is that cylinder 95 is allowed to rotate with respect to cylinder support 117 and cylinder support 118. Multilayer laminate 93 is then unwound and fed under tabs 112 and 113 and over support bar 115 and serrated edge 119. The desired length of multilayer laminate 93 is pulled from cylinder 95 and cut from the roll with serrated edge 119.

In an alternate embodiment shown in FIGS. 16 and 17, multilayer laminate 203 is rolled on cylinder 205. Cylinder 205 has a diameter in the range of two to four inches and is intended to be hand held but can be fitted in an appropriate dispenser as is common in the art. Multilayer laminate 203 is sectioned into predetermined segments by cuts 215. Cuts 215 are perforated cuts along an axis generally parallel to the rotational axis of cylinder 205 and generally perpendicular to the edges of multilayer laminate 203 thus creating segments generally rectangular in shape. Cuts 215 can section multilayer laminate 203 into segments all having equal lengths or cuts 215 may be manufactured such that the predetermined lengths of each segment vary. Cuts 215 may also be positioned at an angle ranging from 30 to 60 degrees from the rotational axis of the cylinder to create segments that are generally triangular in shape.

Referring to FIG. 17, multilayer laminate 203 has four layers. The first layer, substrate 224, provides backing for the second layer, first adhesive coating 221, and the third layer, second adhesive coating 222. The fourth layer, two piece release layer 223, is releasably adhered to substrate 224 by first adhesive coating 221. Substrate 224, first adhesive coating 221, and second adhesive coating 222 are generally transparent. First adhesive coating 221 and second adhesive coating 222 are preferably polyacrylate or similar water based adhesive. The amount, color, and pattern of the adhesive can be as described in any of the previous embodiments.

Multilayer laminate 203 is generally stored in and deployed from a rolled position, therefore both sides of release layer 223 are treated with paraffin or equivalent so as to be easily separated from first adhesive coating 221 and second adhesive coating 222 during deployment and use. Two piece release layer 223 is further longitudinally bisected into two equal width separate portions along division 211. Each separate portion of release layer 223 is adjacent to and do not overlap a linear axis of division 211.

In use, multilayer laminate 203 is unrolled off of cylinder 205 and exposes first adhesive coating 221. Once the desired length of multilayer laminate 203 is reached, a user tears a segment of multilayer laminate 203 off of cylinder 205 via one of the perforated cuts 215. One or several cuts 215 may be skipped in order to reach the desired length. The segment is positioned in a locale where pet deterrence is desired using first adhesive coating 221 to releasably hold the segment in place. If necessary, the segment may be repositioned after it has been put in place. The segment may also be cut or trimmed to a desired shape. Once the segment is placed, two piece release layer 223 is removed one piece at a time. It will be appreciated by those in the art that it would be difficult to remove the release layer if it were just one piece. Wrinkling, tearing, or other damage to substrate 224 might occur otherwise. Substrate 224 is now in place with second adhesive coating 222 exposed. When a pet comes into contact with second adhesive coating 222, it receives an unpleasant sticking sensation which deters the pet from future contact in that area. Once pet deterrence is no longer desired, substrate 224 may be easily removed by simply peeling it away from the surface it is adhered to. First adhesive coating 221 will leave no residue once removed. The multilayer laminate is easily removable and can be easily reapplied to another location where pet deterrence is desired.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

The patentees do not intend to dedicate any disclosed embodiments to the public, and to the extent any disclosed modifications or alterations may not literally fall within the scope of the claims, they are considered to be part of the invention under the doctrine of equivalents.

1. An apparatus for deterring pets from clawing home furnishings comprising:
a removable, multilayer laminate rolled on a cylinder wherein the laminate is divided into a plurality of segments by a plurality of perforated cuts;
the laminate further comprised of a first transparent adhesive layer adjacent a transparent substrate, a second transparent adhesive layer adjacent the substrate, and a release layer adjacent the second adhesive layer;
wherein the release layer is longitudinally bisected into a first release portion and a second release portion having equal widths by a linear cut; and,
wherein the first adhesive layer is removably adhered to the home furnishings and the second adhesive layer contacts the pets providing an unpleasant sticking sensation.

2. The apparatus of claim 1 wherein the diameter of the cylinder ranges from 2 inches to four inches.

3. The apparatus of claim 1 wherein the plurality of perforated cuts are generally parallel to the rotational axis of the cylinder.

4. The apparatus of claim 1 wherein the segments are generally rectangular.

5. The apparatus of claim 1 wherein the plurality of perforated cuts are at an angle ranging from 30 to 60 degrees from the rotational axis of the cylinder.

6. The apparatus of claim 1 wherein the plurality of cuts are equally spaced from each other.

7. The apparatus of claim 1 wherein the space between each cut of the plurality of cuts varies.

8. The apparatus of claim 1 wherein the first release portion and the second release portion are adjacent to and do not overlap the linear cut.

9. The apparatus of claim 1 wherein at least one of the first adhesive layer and the second adhesive layer is polyacrylate.

10. The apparatus of claim 1 wherein both sides of the release layer are treated with paraffin.

11. A method for deterring pets from clawing home furnishings comprising:
providing a multilayer laminate rolled onto a cylinder, where the laminate is comprised of a first adhesive layer adjacent a substrate, a second adhesive layer adjacent the substrate, and a bisected release layer comprised of a first release portion and a second release portion adjacent the second adhesive layer, further wherein the laminate is divided into segments by a plurality of perforated cuts;
determining a location where pet deterrence is desired;
unrolling a desired length of the laminate from the cylinder exposing the first adhesive layer;
tearing the desired length of the laminate off the cylinder at one of the plurality of perforated cuts;
positioning the laminate in the location where pet deterrence is desired;
removing the first release portion;
removing the second release portion;
exposing the second adhesive layer to deter pets from clawing the desired location.

12. The method of claim 11 wherein the step of determining a location where pet deterrence is desired if further comprised of selecting a piece of home furnishing.

13. The method of claim 11 wherein the step of unrolling a desired length of the laminate from the cylinder is by hand.

14. The method of claim 11 wherein the step of unrolling a desired length of the laminate from the cylinder incorporates a dispenser.

15. The method of claim 11 wherein the step of tearing the desired length of the laminate off the cylinder further comprises tearing the laminate off at one of the plurality of perforated cuts generally parallel with the rotational axis of the cylinder.

16. The method of claim 11 wherein the step of tearing the desired length of the laminate off the cylinder further comprises tearing the laminate off at an angle ranging from 30 to 60 degrees from the rotational axis of the cylinder.

17. The method of claim 11 wherein the step of positioning the laminate further comprises removing the laminate and repositioning the laminate.

18. The method of claim 11 wherein the step of positioning the laminate further comprises trimming the laminate into a desired shape.

19. The method of claim 11 wherein the steps of removing the first release portion and removing the second release portion further comprise avoiding wrinkling, tearing or otherwise damaging the substrate.
